(19) United States
(12) Patent Application Publication
(10) Pub. No.: US 2016/0298662 A1
(43) Pub. Date: Oct. 13, 2016

(54) FLUID MANIFOLD

(71) Applicant: EMERALD2 SYSTEMS, L.L.C., MENTOR, OH (US)

(72) Inventor: WILLIAM P. TAYLOR, MENTOR, OH (US)

(21) Appl. No.: 15/002,432

(22) Filed: Jan. 21, 2016

Related U.S. Application Data
(60) Provisional application No. 62/144,403, filed on Apr. 8, 2015.

(51) Int. Cl. F15D 1/02

(52) U.S. Cl. CPC F15D 1/025

(57) ABSTRACT

A fluid manifold includes a block with a first aperture, a second aperture, and a curved fluid passage fabricated, via an additive manufacturing process, through the block between the first aperture and the second aperture. The curved fluid passage surrounds a cavity and includes a non-zero radius of curvature. A fluid manifold includes a volume of material and a fluid passage fabricated, via an additive manufacturing process, through the volume of material. The fluid passage includes a first passive element having a first diameter, a second passive element having a second diameter, and an orifice having a third diameter. The orifice is located between the first and second passive elements. The first and second diameters are smaller than the third diameter. A fluid manifold having a single block of material with a curved passage fabricated through the single block of material is prepared by an additive manufacturing process.

### CROSS-REFERENCE TO RELATED APPLICATIONS

This application claims the benefit of U.S. Provisional Application Ser. No. 62/144,403, filed Apr. 8, 2015, and entitled “METHOD FOR THE MANUFACTURE OF FLUID MANIFOLDS UTILIZING ADDITIVE MANUFACTURING TECHNOLOGY,” which is hereby incorporated by reference in its entirety.

### TECHNICAL FIELD

The following generally relates to a manifold and more particularly to a fluid manifold.

### BACKGROUND OF THE INVENTION

The hydraulic integrated circuit is one of the foundations of modern hydraulic technology and is indispensable across a wide range of applications and has experienced explosive growth in use over the last few decades. Hydraulic integrated circuits have widespread use in mobile equipment because their compact and modular designs simplify installation and troubleshooting; reduce leakage through reduced number of interconnections, and offer substantially lower manufacturing and installation costs. The hydraulic integrated circuit finds its analog in the electronic form of the integrated circuit (IC) where a number of discrete functions and logic functions are combined into one compact package.

The hydraulic integrated circuit is comprised of one or more passive and/or active component (i.e. hydraulic manifold, cartridge valve, insertion valve, face mount valve). A key component of the hydraulic integrated circuit is the fluid manifold. The fluid manifold is a fabricated (typically machined) chamber having multiple apertures for making connections to the required hoses, components and devices, valves, tubes and the like. FIGS. 1 and 2 depict a prior art example fluid manifold 100. FIG. 2 shows FIG. 1 with transparent sides so that the internal structure can be visualized. The fluid manifold 100 includes a single block of material 102 with a hydraulic cartridge valve cavity 104, mounting holes 106, and fluid passages 108 fabricated therein. The fluid manifold 100 reflects a traditional subtractive manufactured fluid manifold for use with a screw in type cartridge valve.

The structural design and subtractive manufacturing of a fluid manifold is a cause of a large proportion of the total energy loss, increased fluid noise and heat generation in a hydraulic system. This loss is primarily due to the fluid manifold's internal flow passages. Limitations in machining processes often dictate and restrict the layout and manufacture of the hydraulic integrated circuit. Typically, component interconnections require crossover passages (cross drillings) that must be designed and constructed to intersect at acute, right, obtuse or reflex angles to accommodate drilling, milling, boring functions and the like. Also, internal manifold chambers must meet these fabrication limitations causing sudden cavity enlargements and or sudden contractions. Unfortunately, these component interconnections produce excessive fluid vortices and eddy formations that result in excessive energy losses and fluid noise. For example, the manifold 100 is fabricated with right angles 110 that induce vortices 112.

Fluid manifolds designed and constructed to accommodate processes of drilling, milling, boring functions and the like must meet the limitations of this form of fabrication. Typically, once designed the fluid manifold will be fabricated by any of various processes in which a piece of raw material is cut into a desired final shape and size by a controlled material-removal process. The many processes that have this common theme, controlled material removal, are collectively known as subtractive manufacturing. Subtractive processes remove undesired materials to achieve desired forms. However, cost limitations and access to the internal portions of the manifold result in fluid manifolds that are heavier, larger in physical size, energy inefficient result in the waste of manufacturing materials.

### SUMMARY OF THE INVENTION

Aspects of the application address the above matters, and others.

The fluid manifold described herein is designed and manufactured utilizing additive manufacturing. In one instance, this allows for reduced weight, reduced physical size, improved system energy efficiency, and reduced use of manufacturing materials, etc. as compared to subtractive and/or other manufacturing processes.

In one instance, a fluid manifold includes a single block of material with a first aperture, a second aperture, and a curved fluid passage fabricated through the block of material between the first aperture and the second aperture. The curved fluid passage surrounds a cavity and includes a non-zero radius of curvature.

Ia fluid manifold includes a volume of material and a fluid passage fabricated through the volume of material. The fluid passage includes a first passive element having a first diameter, a second passive element having a second diameter, and an orifice having a third diameter. The orifice is located between the first and second passive elements. The first and second diameters are smaller than the third diameter. a fluid manifold, which has a single block of material with a curved passage fabricated through the single block of material, is prepared by an additive manufacturing process.

A feature is that the fluid passages are fabricated during the additive manufacturing with radius curves in place of angular cross drillings providing reduced fluid vortices and increased energy efficient.

Another feature is that the fluid passages fabricated during the additive manufacturing are so fabricated as that internal passages form a heat exchanger for efficient heat transfer from one medium to another, the media would be separated by a solid wall to prevent mixing and can be configured as parallel-flow, counter-flow, counter-current or cross-flow heat exchangers.

Another feature is that the fluid passages fabricated during the additive manufacturing are so fabricated as that internal passages form an active component such as a check valve or shuttle valve. During the additive manufacturing process, a ball, a spool or a plug and the like is manufactured internally to function as an active circuit component.

Another feature is that the fluid passages fabricated during the additive manufacturing are so fabricated as that internal passages form a passive component such as a precision orifice, fluid filter screen, filter element or the like.

Another feature is that material not required to produce a functional fluid manifold can be omitted from the additive manufacturing process. This results in a reduced material use and a reduction of manufacturing time and costs.

Another feature is that material not required to produce a functional fluid manifold can be omitted from the additive manufacturing process. This results in a fluid manifold reduced weight.

Another feature is that the fluid passages are fabricated during the additive manufacturing with radius curves in place of angular cross drillings allowing for the removal of the cross drilling pilot drilling This allows for a reduction of fluid manifold physical size.

Another feature includes using alternating materials during the additive manufacturing process to allow for lined fluid passages, thereby allowing fluids of different corrosiveness to be present in the same fluid manifold.

Another feature includes using alternating materials during the additive manufacturing process to allow a corrosion resistant coating to encase the fluid manifold, thereby reducing the manufacturing time and cost by eliminating the need for a plating operation.

Another feature includes manufacturing manifold accessories that would traditionally be separate components, such as captive mounting hardware and the like during the additive manufacturing process. Those skilled in the art will recognize still other aspects of the present application upon reading and understanding the attached description.

### DESCRIPTION OF THE DRAWINGS

The application is illustrated by way of example and not limited by the figures of the accompanying drawings, in which like references indicate similar elements and in which:

FIG. 1 schematically illustrates a perspective view of a prior art screw in type cartridge valve manifold;

FIG. 2 schematically illustrates a perspective view of the prior art manifold of FIG. 1, showing internal structure relative to the external body;

FIG. 3 schematically illustrates a perspective view of an example fluid manifold;

FIG. 4 schematically illustrates a perspective view of the fluid manifold of FIG. 3, showing internal structure relative to the external body;

FIG. 5 schematically illustrates a perspective view of an example fluid manifold with an internal passage having a radius of curvature;

FIG. 6 schematically illustrates a cross-sectional view of the fluid manifold of FIG. 5 along line A-A;

FIG. 7 schematically illustrates a perspective view of the cross-sectional view of FIG. 6;

FIG. 8 schematically illustrates an example manifold configured as a heat exchanger;

FIG. 9 schematically illustrates an example manifold with internal passages that form an active component;

FIG. 10 schematically illustrates an example manifold with internal passages that form a passive component;

FIG. 11 schematically illustrates an example manifold with a corrosive resistant layer(s);

FIG. 12 schematically illustrates an example manifold with accessories;

FIG. 13 schematically illustrates an example of the accessory of FIG. 11; and

FIGS. 14, 15 and 16 schematically illustrate “L” shaped manifolds.

### DETAILED DESCRIPTION OF THE INVENTION

The following describes a manifold configured with a chamber and a passage through which a material (e.g., a liquid, a gas, a solid, etc.) is distributed, gathered, etc., and/or one or more other manifolds. The manifold, which is constructed through an additive manufacturing technology such as 3-D printing, has reduced weight, reduced physical size, improved system energy efficiency, reduced use of manufacturing materials and/or reduced cost, relative to a configuration fabricated via subtractive and/or other manufacturing process, which might leave undesired and/or unneeded material in and/or on the manifold.

As utilized herein, additive manufacturing includes a process of making a three-dimensional solid object of virtually any shape (e.g., square, rectangular, “L”, irregular, etc.) from a digital model. One approach utilizes powdered material dispersed across the manufacturing machine's base plate in layers, allowing for the required detail resolution, and fused together by using an energy source (i.e. laser beam, heater) or bonding agent or the like. Another approach uses a filament of the desired material instead of a powder. The filament is deposited across the manufacturing machine's base plate in layers, allowing for the required detail resolution. Through the use of additive manufacturing, objects with complex geometries can be built all at one time or in steps, reducing the time and cost of conventional tooling.

For explanatory purposes, the fluid manifold is described herein in connection with particular configurations. However, it is to be understood that the illustrated configurations are not limiting, and other configurations are contemplated herein. In general, example applications for the manifold described herein and/or modifications thereto include, but are not limited to, active and/or passive control of fluids used in the fluid power industry such as mineral based hydraulic fluid, synthetic hydraulic fluid, compressed air and gas, water based fluids and other fluids as used in industrial, mobile and aerospace applications, and the like.

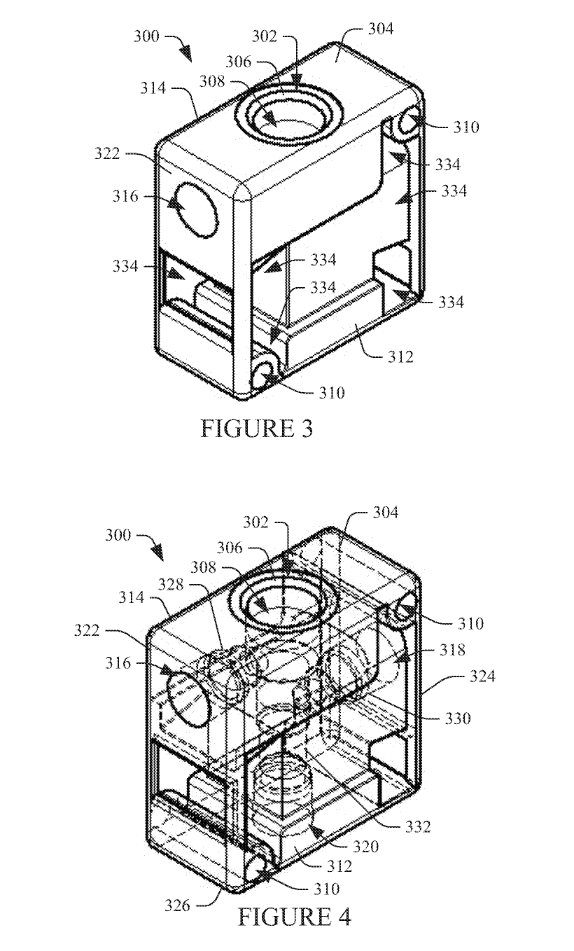

FIGS. 3 and 4 schematically illustrate an example fluid manifold 300. FIG. 4 shows the manifold 300 with transparent sides so that internal structure can be visualized. The illustrated fluid manifold 300 is a single block of material shaped as a rectangular volume with six sides. However, it is to be understood that other geometries are also contemplated herein. The fluid manifold 300 includes an aperture 302 on a first side 304 and a mechanical interface 306 for a hydraulic cartridge valve. The aperture 302 provides an opening for a material free volume or cavity 308 within the manifold 300. The fluid manifold 300 further includes one or more mounting holes 310 extending entirely through rectangular volume between second and third sides 312 and 314. The fluid manifold 300 further includes apertures 316, 318 and 320 on sides 322, 324 and 326, respectively, with fluid passages 328, 330 and 332 to the cavity 308.

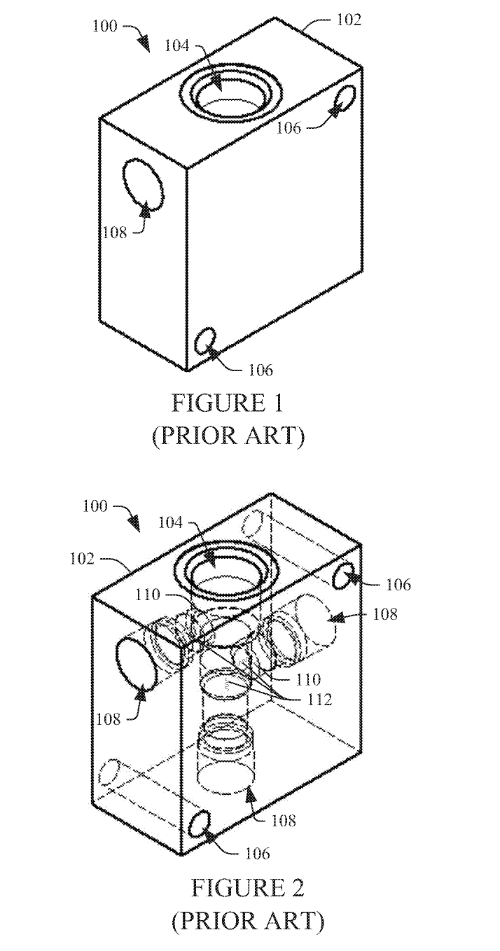

In one instance, producing the fluid manifold 300 through an additive manufacturing technique such as, for example, 3-D printing and/or other additive manufacturing technique, reduces materials required to manufacture the fluid manifold 300, e.g., relative to the configuration of the manifold 100 in FIGS. 1 and 2, which is otherwise manufactured, e.g., through a subtractive manufacturing process of like materials. For example, the prior art configuration of FIGS. 1 and 2 are solid blocks except for the material removed for the cavity 104, the mounting holes 106, and the fluid passages 108.

In FIG. 3, the manifold 300 includes several material free regions 334 within the manifold 300 but outside of the cavity 308, the mounting holes 310, and the fluid passages 328, 330 and 332, thus having less material than the manifold 100. Generally, any material not required to produce a functional fluid manifold can be omitted from the additive manufacturing process. This results in a reduction of the material used and a reduction of manufacturing time and material costs. This may also result in a reduction of weight. For example, in one instance, the fluid manifold 300 has a first weight and the fluid manifold 100 has a second weight, and the first weight is on an order of 1% to 50% less than the second weight.

By alternating materials during the additive manufacturing process, a corrosion resistant layer 336 can be added to line fluid passages thereby allowing fluids of different corrosiveness to be present in the same fluid manifold. This allows for alternate lower cost materials to be used for the supporting structure of the fluid manifold, thereby reducing the overall cost of the manifold. An example is shown in FIG. 11, which shows a manifold 1100, with a passage 1102 and a corrosion resistant layer 1104 at an aperture 1106. By alternating materials during the additive manufacturing process, a corrosion resistant layer can be added to encase the fluid manifold, thereby reducing the manufacturing time and cost by eliminating the need for a plating operation. An example is shown in FIG. 11, which shows the manifold 1100 with a manifold material 1108 and corrosion resistant outer layer 1110 over the manifold material 1108.

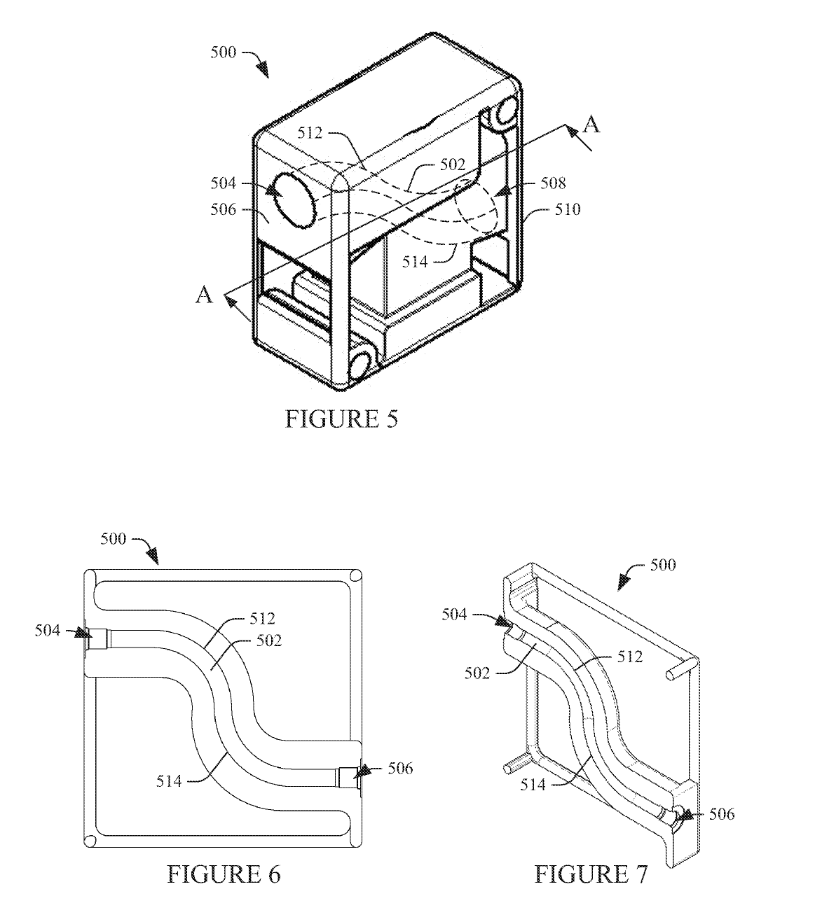

Returning to FIGS. 3 and 4, the fluid passages 328 and 330 are perpendicular to the fluid passage 332 and the cavity 308. As a result, a passage from one side to another side may include one or more right angles. In a variation, one or more of the fluid passages 328, 330 and 332 may alternatively run diagonal to the cavity 308. In this variation, a fluid passage from one side to another side may include a bend at an angle less than or greater than ninety degrees. In another variation, a passage may include a curve or bend defined via a radius curve in place of an angular cross drilling. This mitigates vortices and allows for a reduction of fluid manifold physical size. A non-limiting example is shown in connection with FIGS. 5, 6, 7 and 8.

FIG. 5 shows a perspective view of a manifold 500 with a passage 502 that extends from a first aperture 504 on a first side 506 to a second aperture 508 on a second opposing side 510. FIG. 6 shows a cross-sectional view through lines A-A of FIG. 5, and FIG. 7 shows a perspective view of the cross-sectional view through lines A-A of FIG. 5. In this example, the fluid passage 502 is fabricated during additive manufacturing with non-zero radius curves 512 and 514 (in place of angular cross drillings, as with FIGS. 1 and 2), providing reduced material, size (e g , eliminating the material previously required only for the purpose of the cross drilling pilot drilling) and fluid vortices, and increased energy efficiency. In one instance, the fluid manifold 500 has a first efficiency and the manifold of FIGS. 1 and 2 have a second different efficiency, and the first efficiency is on an order of 1% to 50% more efficient than the second efficiency.

Examples of non-zero radius curves include a radius of a tenth of a mil (254 microns) to five (5) inches (127 millimeters). A smaller and/or a larger radius is also contemplated herein. In general, any radius configured to allow a required flow for the particular application is contemplated herein. For example, in one non-limiting instance, a radius is 0.01825 inches (or 463.55 microns) and would allow 0.2 gallons per minute (GPM) at 3000 pound per square inch (PSI) and keep the fluid velocity at approximately 20 feet per second (ft/sec), for a predetermined maximum PSI for a hydraulic application. In another instance, the radius is configured for pressures of 1 to 10,000 or greater PSI, such as 50-100 PSI. Furthermore, the passage 502 may have more than two curves, and at least two curves may have different radii.

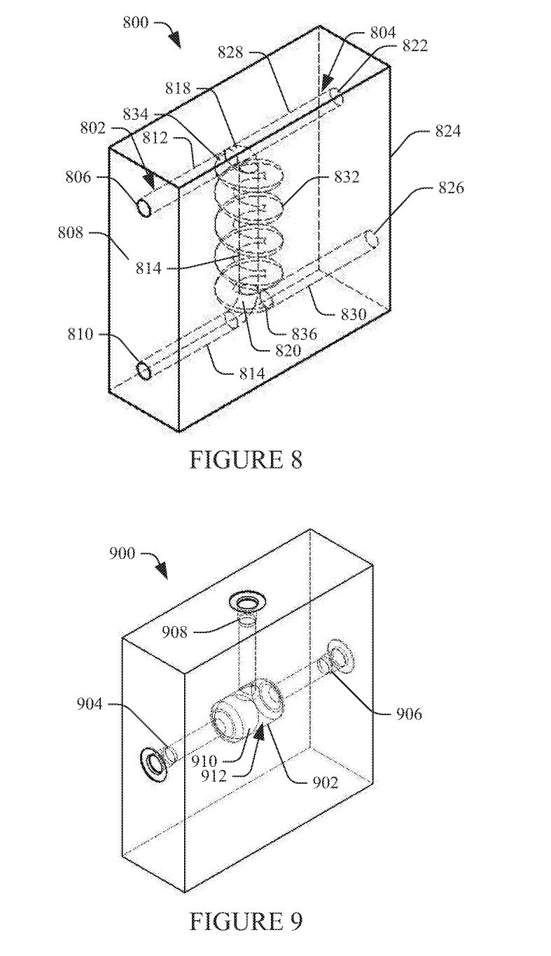

FIG. 8 schematically illustrates manifold 800 with fluid passages 802 and 804. The passage 802 extends from a first aperture 806 in a first side 808, into the manifold 800, to a second aperture 810 on the first side 808. The passage 802 has three legs 812, 814 and 816, where the first and third legs 812 and 816 run generally perpendicular to the first side 808, the second leg 814 runs parallel to the first side 808, between the first and third legs 812 and 816, and connects to the first and third legs 812 and 816, forming the single passage 802. The second leg 814 joins the first and second legs 812 and 816 at curved bends 818 and 820, which have predetermined radii of curvature.

The passage 804 extends from a third aperture 822 in a second side 824, into the manifold 800, to a fourth aperture 826 on the first side 824. The passage 804 has three legs 828, 830 and 832, where the first and third legs 828 and 832 run generally perpendicular to the first side 808, the second leg 830 is configured as a helix that surrounds the second leg 814 (where the second leg 814 extends through a core of the helix), and connects to the first and third legs 828 and 830, forming the single passage 804. The second leg 830 joins the first and second legs 828 and 832 at bends 834 and 836, which have predetermined radii of curvature. In this example, the predetermined radii of curvature are constant. In a variation, the predetermined radii of curvature are not constant.

In this configuration, the manifold 800 can operate as a heat exchanger for efficient heat transfer from one medium to another. The media would be separated by a solid wall to prevent mixing. The manifold 800 can be configured as a parallel-flow, counter-flow, counter-current, or cross-flow heat exchanger. Again, the manifold 800, including the passages 802 and 804, is fabricated during the additive manufacturing process. The additive manufacturing eliminates the need for separate heat exchangers and the associated seals, fittings and connections.

FIG. 9 schematically illustrates an example manifold 900. In this example, the manifold 900 includes a shuttle valve 902, a first input passage 904, a second input passage 906, and an outlet passage 908. The passages 904, 906 and 908 are fabricated during the additive manufacturing. With respect to shuttle valve 902, this includes fabricating, during the additive manufacturing process, a ball 910, a spool, a plug or the like internally and in addition to an internal cavity 912 to function as an active circuit component resulting in a reduction of system cost and complexity. In a variation, the valve is a check valve or other valve.

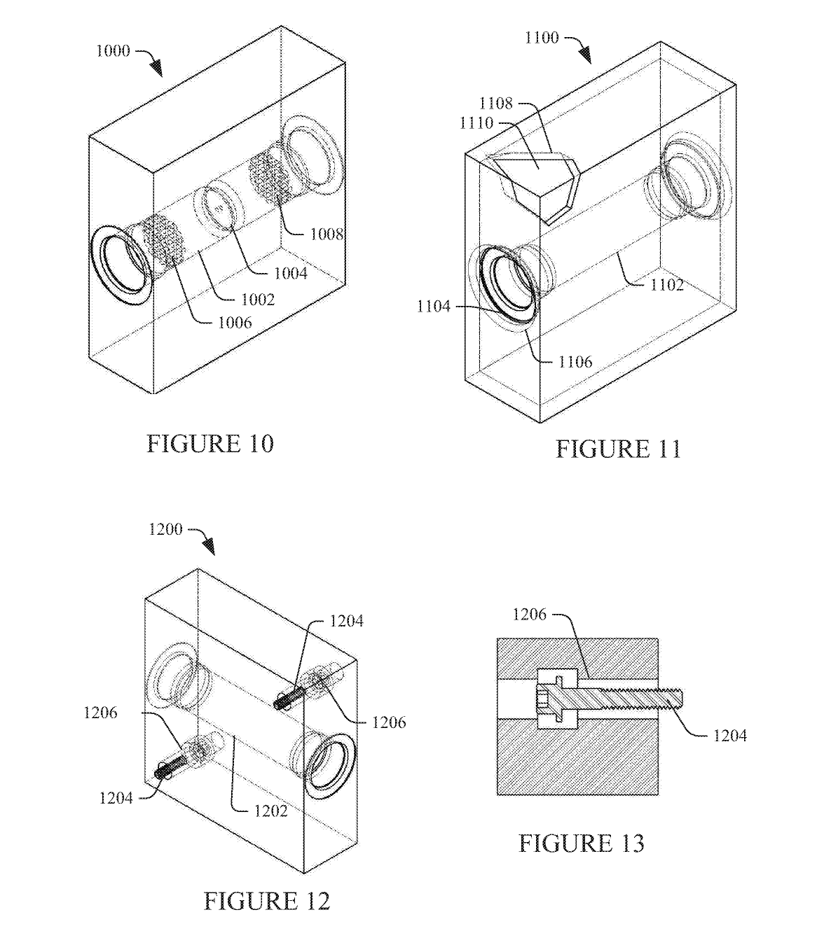

FIG. 10 schematically illustrates an example manifold 1000. In this example, the manifold 1000 includes a fluid passage 1002, an orifice 1004, and fluid filters 1006 and 1008 (e.g., a screen, a mesh, etc.). The fluid passage 1002 is fabricated during the additive manufacturing along with the orifice 1004, and the fluid filters 1006 and 1008. In this example, the filters 1006 and 1008 have first diameters, and the orifice 1004 has a second diameter, and the first diameters are smaller than the second diameter, which is achieved through the additive manufacturing process. This may reduce cost and complexity relative to a subtractive manufacturing process in which the first and second diameters would be the same.

FIG. 12 schematically illustrates an example manifold 1200. In this example, the manifold 1200 includes a passage 1202 and fasteners 1204 in slots 1206. The passage 1202 and fasteners 1204 are concurrently fabricated during the additive manufacturing. As such, upon completion, the fasteners 1204 can function while being captured or retained within the fluid manifold 1200. Passages and fasteners are traditionally manufactured as separate components during an additive manufacturing process. FIG. 13 shows an example of the fastener 1204. In this example, the fastener 1204 includes a socket head cap screw that would traditionally be a separate produced during the additive manufacturing process.

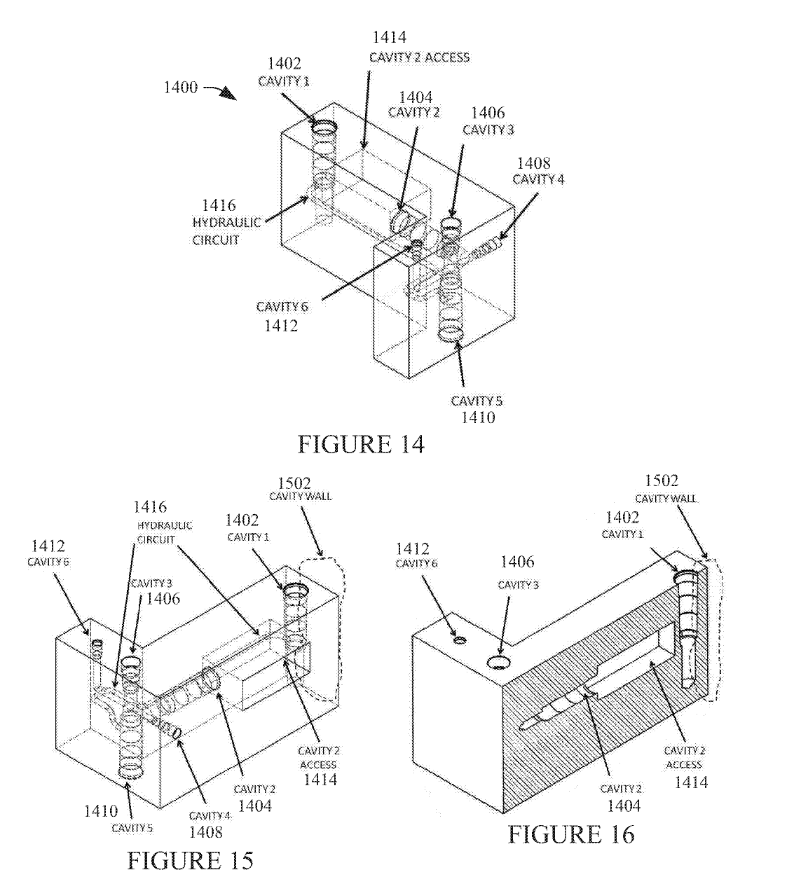

FIGS. 14, 15 and 16 schematically illustrate “L” shaped manifolds 1400, 1500 and 1600. For sake of explanation, the manifolds 1400, 1500 and 1600 are shown with six valve cavities 1402, 1404, 1406, 1408, 1410 and 1412, one cavity access 1414, and an example hydraulic circuit 1416. However, it is to be understood that the manifolds 1400, 1500 and 1600 are no limited and may contain additional and/or alternative components, and/or more or less of the illustrated components.

In this example, the cavity 1402 and the second cavity 1404 are positioned to provide efficient layout with regards to fluid flow, reduced hydraulic circuit length and/or manifold surface. In conventional subtractive manufacturing, the machine tools must be able to access the cavity axis through a cavity wall 1502 (manifold side) to allow for removal of manifold material. Manufacture of the example by subtractive methods would require the cavity 1402 to be relocated.

In this, the material is not deposited during the additive manufacturing process and allows for non-traditional cavity placement and unexpected efficiencies in both manifold layout and fluid flow properties. The cavity access 1414 is provided to allow the cartridge valve to be installed and can be of the required geometry, i.e., oval, circular, rectangular, spatial and/or other form. The cavity access 1414 does not penetrate through the entire manifold 1400, 1500 or 1600 block and allows the hydraulic circuit 1416 to lay axially in line with the cavity 1404.

Similar to FIGS. 3 and 4, corrosion resistant materials can be used and/or material not required to produce a functional fluid manifold can be omitted from one or more of the configurations in FIGS. 5-16.

The application has been described with reference to various embodiments. Modifications and alterations will occur to others upon reading the application. It is intended that the invention be construed as including all such modifications and alterations, including insofar as they come within the scope of the appended claims and the equivalents thereof.

What is claimed is:

1. A fluid manifold, comprising:
a single block of material, including:
a first aperture; and
a second aperture; and
a curved fluid passage fabricated, via an additive manufacturing process, through the block of material between the first aperture and the second aperture,
wherein the curved fluid passage surrounds a cavity and includes a non-zero radius of curvature.

2. The fluid manifold of claim 1, wherein a value of the non-zero radius of curvature is on the order of X to Y.

3. The fluid manifold of claim 1, wherein the single block of material includes a material free region that is both inside of the block of material and outside of the first apertures, the second aperture and the curved passage.

4. The fluid manifold of claim 3, wherein the material free region corresponds to a non-functional sub-portion of the fluid manifold.

5. The fluid manifold of claim 1, further comprising:
a corrosion resistant layer fabricated on at least one of the first or second apertures.

6. The fluid manifold of claim 1, further comprising:
a corrosion resistant layer fabricated on the single block of material.

7. The fluid manifold of claim 1, further comprising:
a slot fabricated in the single block of material; and
a fastener fabricated in the slot.

8. The fluid manifold of claim 7, wherein the fastener is a socket head cap screw.

9. The fluid manifold of claim 1, further comprising:
a first passive element integrated in the passage and having a first diameter;
a second passive element integrated in the passage and having a second diameter; and
an orifice having a third diameter and located between the first and second passive elements,
wherein the first and second diameters are smaller than the third diameter.

10. The fluid manifold of claim 9, wherein the first and second passive elements are filter screens.

11. The fluid manifold of claim 1, further comprising:
a third aperture;
a fourth aperture; and
a second passage fabricated through the single block of material between the third aperture and the fourth aperture,
wherein a sub-portion of the curved passage partially surrounds the second passage.

12. The fluid manifold of claim 11, wherein the sub-portion has a helix shape.

13. The fluid manifold of claim 1, further comprising:
an active circuit component;
a first input passage to the active circuit component;
a second input passage to the active circuit component; and
an outlet passage from the active circuit component.

14. The fluid manifold of claim 11, wherein the active circuit component is a shuttle valve with an internal cavity and one of a ball, a spool, or a plug in the internal cavity.

15. A fluid manifold, comprising:
a volume of material;
a fluid passage fabricated, via an additive manufacturing process, through the volume of material, wherein the fluid passage includes:
a first passive element having a first diameter;
a second passive element having a second diameter; and
an orifice having a third diameter, wherein the orifice is located between the first and second passive elements,
wherein the first and second diameters are smaller than the third diameter.

16. The fluid manifold of claim 15, wherein the first and second passive elements are meshes.

17. A fluid manifold having a single block of material with a curved passage fabricated through the single block of material is prepared by an additive manufacturing process.

18. The fluid manifold of claim 17, wherein the additive manufacturing process comprises:
dispersing a first powdered material across a base plate in a first layer;
fusing the first powdered material together;
dispersing a second powdered material across the fused first powdered material on the base plate in a second layer;
fusing the second powdered material together.

19. The fluid manifold of claim 17, wherein the additive manufacturing process comprises:
depositing a first filament across a base plate in a first layer;
fusing the first filament together;
dispersing a second first filament across the fused first filament on the base plate in a second layer;
fusing the second filament together.

20. The fluid manifold of claim 17, wherein the additive manufacturing process is 3-D printing.
